(19) United States
(12) Patent Application Publication
(10) Pub. No.: US 2020/0200556 A1
(43) Pub. Date: Jun. 25, 2020

(54) SYSTEMS AND METHODS FOR VEHICLE-BASED TOURS

(71) Applicant: Ford Global Technologies, LLC, Dearborn, MI (US)

(72) Inventors: Daniel Boston, Dearborn, MI (US); Jimmy Kapadia, Ottawa Hills, OH (US)

(73) Assignee: Ford Global Technologies, LLC, Dearborn, MI (US)

(21) Appl. No.: 16/225,862

(22) Filed: Dec. 19, 2018

(51) Int. Cl. G01C 21/34; G01C 21/36

(52) U.S. Cl. CPC G01C 21/3476; G01C 21/343; G01C 21/3614; G01C 21/3682; G01C 21/3644

(57) ABSTRACT

Systems, methods, and computer-readable media are disclosed for providing information related to landmarks during travel. Example methods may include determining a set of landmark options based at least in part on a input indicative of locations, the set of landmark options comprising a landmark option; determining that the landmark option is selected by a user; determining a tour route based on the landmark option, wherein the tour route includes at least one landmark; and determining information to be provided to the user when the user is within a distance of the at least one landmark.

### TECHNICAL FIELD

The present disclosure relates to systems, methods, and computer-readable media for vehicle-based tours.

### BACKGROUND

Users may be interested in finding and visiting various locations. For example, a user may be interested in visiting a location of historical interest. In addition, the user may desire to view other locations of interest, such as parks or other locations that may be near the location of historical interest. However, the user may not be aware of nearby locations of interest. In addition, the user may desire to view or visit various locations of interest without advance scheduling.

### BRIEF DESCRIPTION OF THE DRAWINGS

FIG. 1 shows a diagram of an environmental context for providing vehicle-based tours, in accordance with one or more embodiments of the disclosure.

FIG. 2 is a schematic illustration of an example implementation of presenting relevant local information, in accordance with one or more embodiments of the disclosure.

FIG. 3 is a schematic illustration of an example implementation of a tour for vehicles, in accordance with one or more embodiments of the disclosure.

FIG. 4 shows an example process flow for a method of providing vehicle tours and landmark information, in accordance with one or more embodiments of the disclosure.

FIG. 5 is a schematic illustration of an example autonomous vehicle, in accordance with one or more embodiments of the disclosure.

FIG. 6 is a block diagram of an example computer architecture, in accordance with one or more embodiments of the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Users may be interested in finding and visiting various locations, and may visit such locations using vehicles (e.g., cars, buses, and the like). In various embodiments, passengers of a vehicle making a road trip may become bored, in particular, along long stretches of road. In another aspect, passengers who are not driving may entertain themselves with games, stories, reading, radio broadcasts, combinations thereof, and/or the like. However, such means of entertainment may also become dull after a period of time. Further, the driver of a vehicle may not be able to use all available forms of entertainment, but rather, may be constrained to using primarily audio-based entertainment sources.

In various embodiments, when traveling to a new area or while exploring somewhere close to home, users (e.g., passengers and/or drivers) may have limited knowledge about the surrounding region, or may desire to know more but may need to wait until their journey is over in order to research the area traveled and/or the surrounding area(s) to better understand where the passengers and/or drivers were traveling. The passengers and/or drivers may forget to perform this research. Further, performing such research may waste the drivers' and/or passengers' time after the drive.

In various aspects, embodiments of the disclosure are directed to providing vehicle tours, which may include guided tours provided to passengers and/or drivers traveling in a vehicle. In another embodiment, such tours may provide users with information about the surrounding area (e.g., neighborhood) as they are traveling through a given area. Further, the tours may be catered to show information related to the roads and surrounding areas within a predetermined distance from the roads where the users are traveling.

In various embodiments, passengers and/or drivers may take a predetermined route and may indicate that they want to learn about the area they are traveling through. For example, passengers and/or drivers may want information specific to the location (e.g., city, town, neighborhood) that they travel through on a regular basis. In another embodiment, passengers and/or drivers may want information related to a broader geographical area that they are traveling through (e.g., for long road trips, information about a state or county that the passengers and/or drivers are passing through). In one embodiment, the passengers and/or drivers may provide an input (e.g., a voice input, a textual input, a video input, combinations thereof, and/or the like) requesting information about their location to a device associated with a vehicle in which they are riding.

The device may include one or more devices of the vehicle (e.g., a navigation system of the vehicle), and/or the user's device(s), which may be configured to communicate with a vehicle's devices. In another embodiment, information (e.g., pre-recorded information) about the surrounding area may be searched for on a network (e.g., the Internet), for example, by one or more devices of the vehicle and/or by a corresponding application running on a user device. Non-limiting examples of such information may include historical events which took place nearby a given landmark, nearby restaurants of a given type, and things to do (e.g., sports games to attend, concerts to attend, etc.), combinations thereof, and/or the like. Moreover, the information may, in addition to historical events, include points-of-interest (POIs) and associated events such as restaurants, shows, trivia, combinations thereof, and/or the like. In one embodiment, the information may be tailored for a given user and may be mapped to a given route taken by the user using dynamic routing. In another embodiment, the information may be drawn at least partially from other external sources (e.g., one or more review sites). In various embodiments, the users may provide one or more commands (e.g., voice commands, textual commands, and the like) such as, “what city am I in,” and the response to such commands may be combined with navigation instructions and/or integrated with a personal assistant (e.g., virtual personal assistant) that may be provided by one or more user devices or the vehicle devices that may be configured to provide instantaneous information for a driver or passenger alike. In addition, the information may be tailored to a given user based on examples of what the user has done historically (e.g., places and/or events that the user has attended) on other tour routes taken by the user. In particular, the information may be used to build a user preference profile, and the user preference profile may be, in turn, used to inform the user on what additional activities or locations to visit. Further, the routes may not necessarily have a defined source and destination; rather, the routes may have multiple stops, may cover portions or a geographical area, may be freeform, combinations thereof, and/or the like.

In various embodiments, databases that may store at least portions of the tours and/or routes may be stored in a proprietary network, a server, a storage device, combinations thereof, and/or the like. In another embodiment, the databases may be provided on an open marketplace where users and/or companies can contribute their own catered tours. Further, tours may be ranked by users and/or may be reviewed for quality. In various embodiments, entities such as non-profits or institutions such as museums, universities, libraries, and the like may contribute information about a given area and may simultaneously advertise for their entity. In another embodiment, entities associated with cities may offer guided tours of downtown and tourist-friendly areas to attract tourists. In another embodiment, users who complete a given tour may be offered one or more rewards (e.g., free parking for a downtown garage, free or discounted tickets to an event, and the like). In another embodiment, users and/or entities may pay for the right to have access to tours and/or to advertise tours using the platform. In another embodiment, users who own an asset (e.g., a vehicle) of a given type may be allowed free membership to one or more platforms hosting the tours. In one embodiment, entities such as businesses or cities may pay to advertise during tours so that passengers and/or drivers stop at their local establishments.

In various embodiments, the types of tours that may be prompted to the passengers and/or drivers may be tailored based on a passenger's and/or driver's preferences. For example, if the passengers and/or drivers are interested in food, they can be given information about high-rating local restaurants in the area (e.g., the story behind a restaurant's origination, the types of unique food offerings, comparisons to other restaurants in the area, combinations thereof, and/or the like). As another example, if the passengers and/or drivers are interested in history, information may be given about a historic battle that took place close by a landmark on the route that the passengers and/or drivers are traveling.

In various embodiments, the route history of the vehicle may be saved (e.g., on a memory of a device or on a cloud-based server); accordingly, roads that have been driven on before by the passengers and/or drivers may be highlighted on a map (e.g., a map rendered on a user device or a navigation system of a vehicle) in a specific color (e.g., red) while the other roads may be de-emphasized (e.g., colored grey). In various embodiments, passengers and/or drivers may receive rewards (e.g., tokens, discounts, credits, combinations thereof, and/or the like) for exploring certain areas. For example, passengers and/or drivers may receive rewards for having traveled certain roads and/or a percentage of available roads in a given environment. In one aspect, such an embodiment of the disclosure may serve to encourage passengers and/or drivers to drive or ride in vehicles to explore areas of the city that the passengers and/or drivers might not have traveled to before. In another embodiment, anonymized and aggregated route data may be determined from various passengers and/or drivers, and such anonymized and aggregated route data may be used to indicate (e.g., display via a map rendered on a user device or a navigation system of a vehicle) how many other users have driven down a particular road. Accordingly, such an embodiment may enable users to see what areas of an environment (e.g., a city) they have yet to explore, and/or what areas other users are visiting.

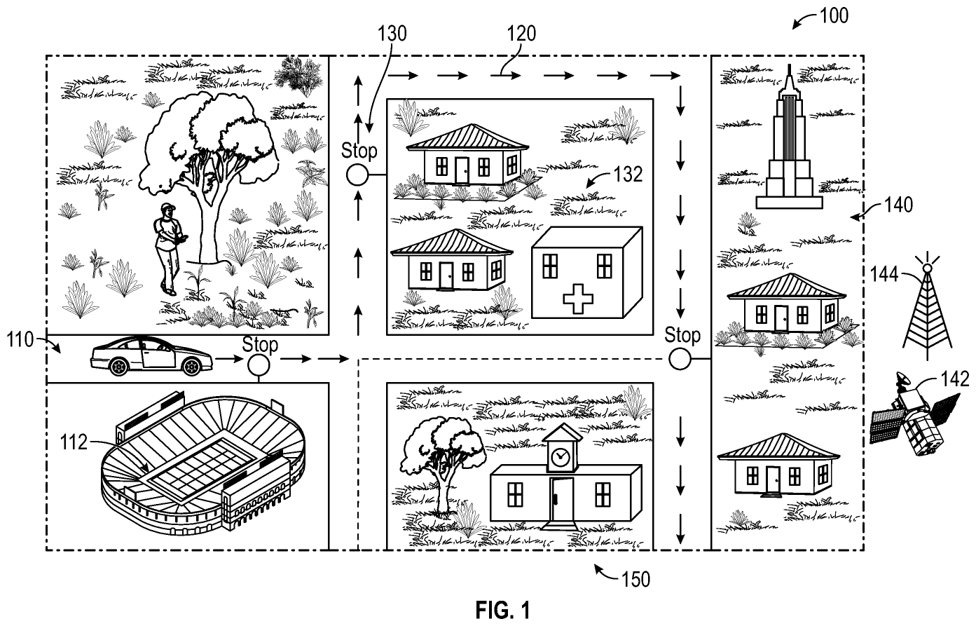

FIG. 1 shows a diagram of an environmental context for providing vehicle-based tours, in accordance with one or more embodiments of the disclosure. As noted, the tours may include a route-specific tour. Such a route-specific tour may have a starting point and an ending point (e.g., a destination). In another embodiment, a navigation system (e.g., a navigation system of a vehicle and/or a navigation system running on one or more user devices such as mobile phones) may be configured to determine a route. Such navigation systems may serve to convey information to the users, for example, by using pre-recorded voice recordings that may be played automatically when users are proximate to one or more landmarks or points-of-interest and based on where the users are along the route they are taking. In another embodiment, such events may be triggered based on a location of the users and/or a proximity to such landmarks and points-of-interest on the route. Various embodiments of the disclosure may combine the information with voice assistance from third-party navigation systems that may be provided with many vehicles. For example, if a driver of a vehicle misses a turn during a navigation session, the third-party navigation system may be configured to navigate the driver to the last landmark or point-of-interest and thereby resume the tour.

In the environmental context 100 shown in FIG. 1, a vehicle 110 (which may include a conventional vehicle or an autonomous vehicle) may drive to a first location with a view of a first landmark such as a stadium 112, and may optionally stop at a suitable location and wait for a user to view the first landmark either within the car or outside of the car. After the user indicates that the user is done viewing the first landmark, the vehicle 110 may proceed along a route 120 to a second stop 130, which may be at a second landmark which may include one or more properties having historical significance 132, at which the user may exit the vehicle 110 and tour or view the second landmark from the vehicle 110. The vehicle 110 may then proceed along the route 120 to a third stop 140, which may be at a third landmark, which may include one or more buildings of touristic significance, at which the user may exit the vehicle 110 and tour or view the third landmark from within the vehicle 110. The vehicle 110 may then proceed along the route 120, which may go past a historical building 150 or another location of interest, and so forth.

As the vehicle 110 drives along the route 120, information related to the landmarks and locations of interest may be presented at one or more displays and/or audio systems of the vehicle 110 and/or the user's device(s). For example, information related to the landmarks illustrated in the example of FIG. 1 may be presented. The information may be sourced from online resources, such as third-party data providers, maps, and other sources, and may be downloaded or streamed by the vehicle 110 for presentation on a display system of the vehicle 110. In some embodiments, the information may be downloaded and/or streamed by a user device of the user, and may be presented on a display of the user device instead of, or in addition to, a display in the vehicle 110. In such instances, one or both of the vehicle 110 and the user device may communicate with one or more remote servers.

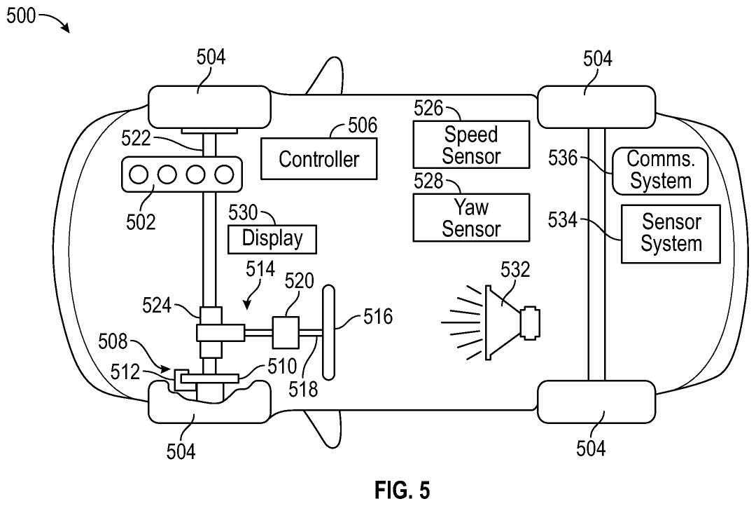

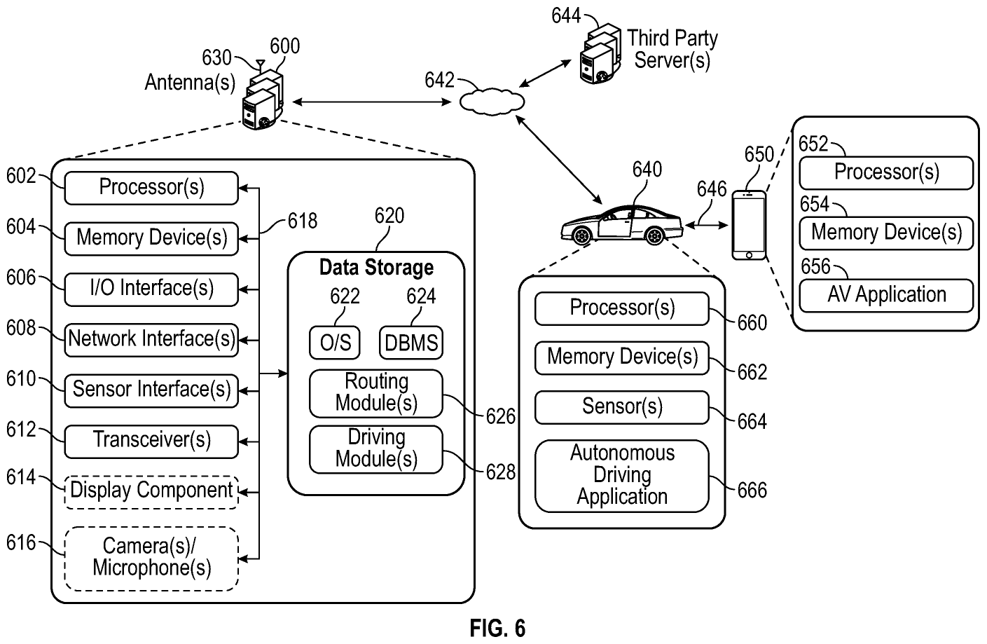

To generate the route 120, one or more computer processors coupled to at least one memory of a computer system (such as one or more remote servers, the vehicle 110, etc.) may determine a first set of inputs indicative of desired landmark preferences (e.g., touristic preferences, food preferences, sports preferences, and the like). The one or more computer processors may correspond to the processor(s) 602 illustrated in FIG. 6 and/or the controller 506 of the vehicle illustrated in FIG. 5. In some embodiments, various operations may be performed by either or both of the vehicle itself (e.g., a controller of the vehicle) or one or more remote servers, such as that illustrated in FIG. 6.

As noted, users may take predetermined routes and may indicate that they want to learn about the area they are traveling through. For example, passengers and/or drivers may want information specific to the location (e.g., city, town, neighborhood) that they travel through on a regular basis. In another embodiment, passengers and/or drivers may want information related to a broader geographical area that they are traveling through (e.g., for long road trips, information about a state or county that the passengers and/or drivers are passing through).

Accordingly, in FIG. 1, the user may desire to view various landmarks. Accordingly, the user may provide a first set of inputs that include preferences and/or requests to see landmarks and/or locations within a given distance of the landmarks. The computer processor(s) may determine a set of landmark options based at least in part on the first set of inputs. For example, the computer processor(s) may query one or more databases or systems. The set of landmark options may include a first landmark option, such as a stadium, a second landmark option, such as one or more houses having historical significance, a third landmark option, such as a building having touristic value, and so forth. The user may select one or more of the options. Alternatively or additionally, the computer processor(s) may determine one or more routes having the landmarks based at least in part on the first set of inputs. Selections may be made using a display and/or microphone of the vehicle 110 and/or using a mobile application executing on a user device, such as a smartphone.

In various embodiments, one or more devices of the vehicle (e.g., a navigation system of the vehicle 110), and/or the user's device(s), may be configured to communicate with a vehicle's devices. In another embodiment, information (e.g., pre-recorded information) about the surrounding area may be searched for on a network (e.g., the Internet), for example, by one or more devices of the vehicle 110 and/or by a corresponding application running on a user device. Non-limiting examples of such information may include historical events which took place nearby a given landmark, nearby restaurants of a given type, and things to do (e.g., sports games to attend, concerts to attend, etc.), combinations thereof, and/or the like.

In one embodiment, the information may be tailored for a given user and may be mapped to a given route taken by the user using dynamic routing. In another embodiment, the information may be drawn at least partially from other external sources (e.g., one or more review sites). In various embodiments, the users may provide one or more commands (e.g., voice commands, textual commands, and the like) such as “what city am I in?” The response to such commands may be combined with navigation instructions and/or integrated with a personal assistant (e.g., virtual personal assistant) that may be provided by one or more user devices or the vehicle 110 devices that may be configured to provide instantaneous information for a driver or passengers.

In various embodiments, databases (not shown) that may store at least portions of the tours and/or routes may be stored in a proprietary network, a server, a storage device, etc. In another embodiment, the databases may be provided on an open marketplace where users and/or companies can contribute their own catered tours. Further, tours may be ranked by users and/or may be reviewed for quality. In various embodiments, entities such as non-profits or institutions such as museums, universities, libraries, and the like may contribute information about a given area and may simultaneously advertise for their entity. In another embodiment, entities associated with cities may offer guided tours of downtown and tourist-friendly areas to attract tourists. In another embodiment, users who complete a given tour may be offered one or more rewards (e.g., free parking for a downtown garage, free or discounted tickets to an event, and the like). In another embodiment, users and/or entities may pay for the right to have access to tours and/or to advertise tours using the platform. In another embodiment, users who own an asset (e.g., a vehicle) of a given type may be allowed free membership to one or more platforms hosting the tours. In one embodiment, entities such as businesses or cities may pay to advertise during tours so that passengers and/or drivers stop at their local establishments.

In various embodiments, the types of tours that may be prompted to the passengers and/or drivers may be tailored based on a passenger's and/or a driver's preferences. For example, if the passengers and/or drivers are interested in food, they can be given information about high-rating local restaurants in the area (e.g., the story behind such a restaurant's origination, the types of unique food offerings, comparisons to other restaurants in the area, combinations thereof, and/or the like). As another example, if the passengers and/or drivers are interested in history, information may be given about a historic battle that took place close by a landmark on the route that the passengers and/or drivers are traveling.

In various embodiments, the route history of the vehicle 110 may be saved (e.g., on a memory of a device or on a cloud-based server); accordingly, roads that have been driven on before by the passengers and/or drivers may be highlighted on a map (e.g., a map rendered on a user device or a navigation system of a vehicle) in a specific color (e.g., red) while the other roads may be de-emphasized (e.g., colored grey). In various embodiments, passengers and/or drivers may receive rewards (e.g., tokens, discounts, credits, combinations thereof, and/or the like) for exploring certain areas. For example, passengers and/or drivers may receive rewards for having traveled certain roads and/or a percentage of available roads in a given environment. In one aspect, such an embodiment of the disclosure may serve to encourage passengers and/or drivers to drive or ride in vehicles to explore areas of the city that the passengers and/or drivers might not have traveled to before. In another embodiment, anonymized and aggregated route data may be determined from various passengers and/or drivers, and such anonymized and aggregated route data may be used to indicate (e.g., display via a map rendered on a user device or a navigation system of a vehicle) how many other users have driven down a particular road. Accordingly, such an embodiment may enable users to see what areas of an environment (e.g., a city) they have yet to explore, and/or what areas other users are visiting.

The computer processor(s) may determine that the first landmark option is selected for viewing by the user, and may determine a route from a current location to a first location of the first landmark option. For example, the user may be at his or her home (current location), and the computer processor(s) may determine a route from the current location to the first landmark. Route determinations may include retrieval and analysis of current traffic data and/or distance to a destination to determine an optimal route and/or order of landmark locations to visit. In some embodiments, the user may arrange the selected landmark options in a desired order.

In some embodiments, a user may select landmark options prior to entering the vehicle 110. In such instances, if the vehicle 110 includes an autonomous vehicle, the computer processor(s) may determine the current location of the user, which may be a pickup location for the user, and may cause the vehicle 110 to drive to the current location to pick up the user.

The user may indicate whether or not the user is interested in a tour of a neighborhood or a general area of a given landmark option. A neighborhood tour may include driving by and/or stopping at various locations of interest, as described herein. If the user is interested, the computer processor(s) may determine that the user is interested in a neighborhood of the first location (e.g., the location of the first landmark in this example), and may generate a neighborhood tour routing for the neighborhood that surrounds the first landmark, which may include points or locations of interest, which may be based on historical information associated with prior tours and/or user preferences and user profiles. The neighborhood tour routing may include identified locations of interest, such as historical buildings, touristic locations, parks, public facilities, shopping malls, and so forth. The computer processor(s) may cause the vehicle 110 to drive along the neighborhood tour routing, which may or may not include the route 120.

In an example process flow, a determination may be made by the vehicle 110 and/or one or more connected servers on whether a user or an occupant of the vehicle 110 has provided any inputs. If not, the process may end. If so, then a determination may be made by the vehicle and/or one or more connected servers on whether any machine learning inputs are available. If not, then the process may end. If so, then a determination may be made by the vehicle 110 and/or one or more connected servers on whether any other landmark options are available within a given radius of the location of the user and the vehicle 110. If so, then the options may be presented at a user device or a display of the vehicle 110. If not, then the process may end. After the options are displayed, a determination may be made by the vehicle 110 and/or one or more connected servers on whether a preferred route has been selected. This determination may be made based at least in part on whether a user has selected a preferred route and/or selected a preferred route type, such as to avoid highways, to avoid tolls, fastest route type, greenest route type, shortest route type, etc. If not, then the process may end. If so, then the vehicle 110, in the case of an autonomous vehicle, may begin driving along the selected route.

For example, the computer processor(s) may determine a route from a current location to a first location of the first landmark option. If the vehicle 110 is an autonomous vehicle, the vehicle 110 may autonomously drive from the current location to the first location. The computer processor(s) may cause the autonomous vehicle to wait at the first location for a predetermined length of time (such as a length of time indicated by the user for viewing the landmark) and may cause the vehicle to autonomously drive from the first location to the second location of the next landmark on the tour.

While in operation, a continuous process may be executed to make a determination by the vehicle 110 and/or one or more connected servers on whether an emergency has occurred. This determination may be made based at least in part on whether the user has indicated the occurrence of an emergency, for example, using the user's device and/or the display of the vehicle 110. If not, the vehicle 110 may continue driving along the path. If so, the vehicle 110 may cancel the landmark tour and, in the case of an autonomous vehicle, may return to a pickup location or a designated emergency location, such as a home, a hospital, or the like.

The tour may include an abort option presented at the display of the vehicle 110 and/or at the user device that allows the user to end the tour at his/her pleasure or in the event of an emergency. The display of the vehicle 110 and/or the user device may include an icon that once selected by the user ends the tour. In one embodiment, in response to a request to abort, the tour may be ended, and the vehicle 110 may plot a second route back to the origin. The second route may be the most efficient route between the vehicle's 110 current location and the origin. The most efficient route may be the shortest distance or the shortest time. If the vehicle 110 is an autonomous vehicle, the vehicle 110 may then execute the second route by generating steering, powertrain, and braking commands in order to autonomously drive the vehicle along the second route.

In various embodiments, the vehicle 110 may be associated with one or more users (e.g., a driver and one or more passengers). In one embodiment, the users may have user devices (e.g., mobile devices, tablets, laptops, and the like). In one embodiment, the vehicle 110 may be any suitable vehicle such as a motorcycle, a car, a truck, a recreational vehicle (RV), a boat, plane, etc., and may be equipped with suitable hardware and software that enables it to communicate over a network, such as a local area network (LAN).

In one embodiment, the vehicle 110 may include an autonomous vehicle (AV). In another embodiment, the vehicle 110 may include a variety of sensors that may aid the vehicle in navigation, such as radio detection and ranging (radar), light detection and ranging (lidar), cameras, magnetometers, ultrasound, barometers, and the like. In one embodiment, the sensors and other devices of the vehicle 110 may communicate over one or more network connections. Examples of suitable network connections include a controller area network (CAN), a media-oriented system transfer (MOST), a local interconnection network (LIN), a cellular network, a WiFi network, and other appropriate connections such as those that conform with known standards and specifications (e.g., one or more Institute of Electrical and Electronics Engineers (IEEE) standards, and the like).

In one embodiment, the vehicle 110 may determine its location based on the one or more visual features. For example, a collection of successive snapshots from a vehicle 110 device's camera can build a database of images that is suitable for estimating location in a given environment. In one embodiment, once the database is built or during the building of such a database, the vehicle 110, while moving through the environment, may take snapshots that can be interpolated into the database, yielding location coordinates. These coordinates can be used in conjunction with other location techniques for higher accuracy of the location of the vehicle 110.

In another aspect, the environmental context 100 may include one or more satellites 142 and one or more cellular towers 144. In another embodiment, the vehicle 110 may include a transceiver, which may, in turn, include one or more location receivers (e.g., GPS receivers) that may receive location signals (e.g., GPS signals) from one or more satellites 142. In another embodiment, a GPS receiver may refer to a device that can receive information from GPS satellites (e.g., satellites 142) and calculate the vehicle's 110 geographical position. Using suitable software, the vehicle may display the position on a map displayed on a human-machine interface (HMI), and the GPS receiver may offer information corresponding to navigational directions.

In one embodiment, GPS navigation services may be implemented based on the geographic position information of the vehicle provided by a GPS-based chipset/component. A user of the vehicle 110 may enter a destination using inputs to an HMI including a display screen, and a route to a destination may be calculated based on the destination address and a current position of the vehicle determined at approximately the time of the route calculation. In another embodiment, turn-by-turn (TBT) directions may further be provided on the display screen corresponding to the GPS component and/or through vocal directions provided through a vehicle audio component. In some implementations, the GPS-based chipset component itself may be configured to determine that the vehicle 110 is about to be within a predetermined distance of a given landmark. For example, the GPS-based chipset/component may execute software that includes the locations of various landmarks and/or locations of interest and that issues a notification when the vehicle travels within a predetermined distance of one or more of the various landmarks and/or locations of interest.

In another embodiment, a location device of the vehicle 110 or a user device (not shown) may use GPS signals received from a global navigation satellite system (GNSS). In another embodiment, a user device (e.g., a smartphone) may also have GPS capability that may be used in conjunction with the GPS receiver, for example, to increase the accuracy of calculating the vehicle's 110 geographical position. In particular, the user's device may use assisted GPS (A-GPS) technology, which can use base station or cellular towers 144 to provide a faster time to first fix (TTFF), for example, when GPS signals are poor or unavailable. In another embodiment, the GPS receiver may be connected to other electronic devices associated with the vehicle 110. Depending on the type of electronic devices and available connectors, connections can be made through a serial or universal service bus (USB) cable, as well as a Bluetooth connection, a compact flash connection, a standard (SD) connection, a personal computer memory card international association (PCMCIA) connection, an ExpressCard connection, and the like.

In various embodiments, the GPS receiver may be configured to use an L5 frequency band (e.g., centered at approximately 1176.45 MHz) to determine a higher accuracy location (e.g., to pinpoint the vehicle 110 to approximately one foot accuracy). In another embodiment, the location device may include the capability to detect location signals from one or more non-GPS-based systems, for example, to increase the location accuracy. For example, the location device may be configured to receive one or more location signals from a Russian global navigation satellite system (GLONASS), a Chinese BeiDou navigation satellite system, a European Union Galileo positioning system, an Indian regional navigation satellite system (IRNSS), and/or a Japanese quasi-zenith satellite system, and the like.

A user device (not shown) may be configured to communicate with the one or more devices of the vehicle 110 using one or more communications networks, wirelessly or wired. Further, the vehicle 110 and/or any devices of the vehicle 110 may be configured to communicate using one or more communications networks, wirelessly or wired. Any of the communications networks may include, but are not limited to, any one of a combination of different types of suitable communications networks such as, for example, broadcasting networks, public networks (for example, the Internet), private networks, wireless networks, cellular networks, or any other suitable private and/or public networks. Further, any of the communications networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The user device(s) (not shown) may include one or more communications antennas. Communications antenna may be any suitable type of antenna corresponding to the communications protocols used by the user device and the devices of the vehicle. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user device.

The user devices may include any suitable radio and/or transceiver for transmitting and/or receiving radio frequency (RF) signals in the bandwidth and/or channels corresponding to the communications protocols utilized by any of the user device and/or the vehicle 110 devices to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n), 5 GHz channels (e.g., 802.11n, 802.11ac), or 60 GHz channels (e.g., 802.11ad). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

Typically, when a device of the vehicle 110 establishes communication with a user device, the device of the vehicle may communicate in the downlink direction by sending data frames (e.g., a data frame which can comprise various fields such as a frame control field, a duration field, an address field, a data field, and a checksum field). The data frames may be preceded by one or more preambles that may be part of one or more headers. These preambles may be used to allow the user device to detect a new incoming data frame from the vehicle device. A preamble may be a signal used in network communications to synchronize transmission timing between two or more devices (e.g., between the vehicle device and user device).

As noted, embodiments of devices and systems (and their various components) described herein can employ artificial intelligence (AI) to facilitate automating one or more features described herein (e.g., determining routes, providing tour information, navigating a route, combinations thereof, and/or the like). The components can employ various AI-based schemes for carrying out various embodiments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc., from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determine an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to, training data. Other directed and undirected model classification approaches include, e.g., naïve Bayes, Bayesian networks, decision trees, neural networks, fuzzy logic models, and/or probabilistic classification models providing different patterns of independence that can be employed. Classification as used herein also is inclusive of statistical regression that is utilized to develop models of priority.

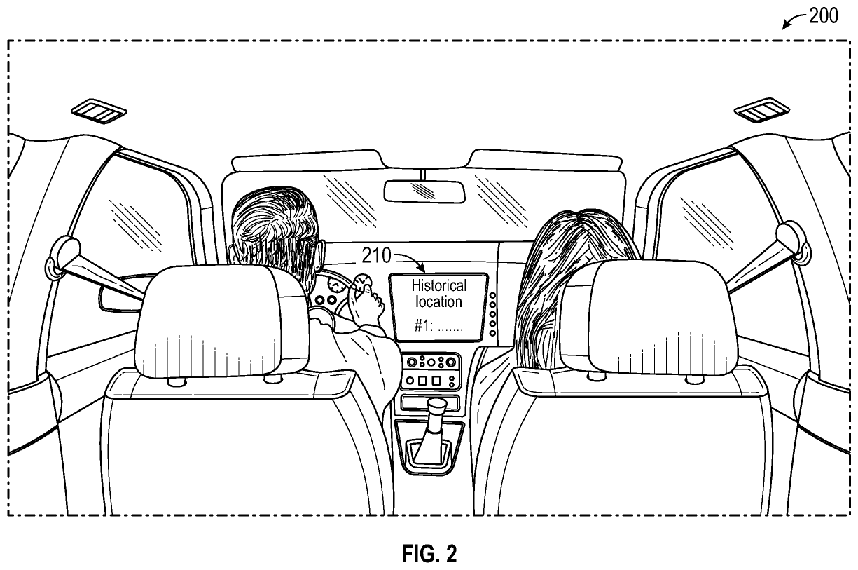

FIG. 2 is a schematic illustration of an example implementation 200 of presenting relevant local information in accordance with one or more embodiments of the disclosure. In the example of FIG. 2, relevant information for a landmark and/or location of interest or an area of a landmark or an area of a route may be presented via a display 210 of a vehicle and/or a user device. For example, relevant events that occur near a first location may be determined and presented to the user. Alternatively or additionally, historical information related to the first location or landmark, and facts such as demographic information, economic information, and the like may be determined and presented to the user.

As noted, in various embodiments, entities may contribute information about a given area and may simultaneously advertise for their entity, and these advertisements may be displayed to the users via the display 210. In another embodiment, entities associated with cities may offer guided tours of downtown and tourist-friendly areas to attract tourists. In one embodiment, entities such as businesses or cities advertise during tours so that passengers and/or drivers stop at their local establishments. All such advertisements and related information may be displayed to the users via the display 210.

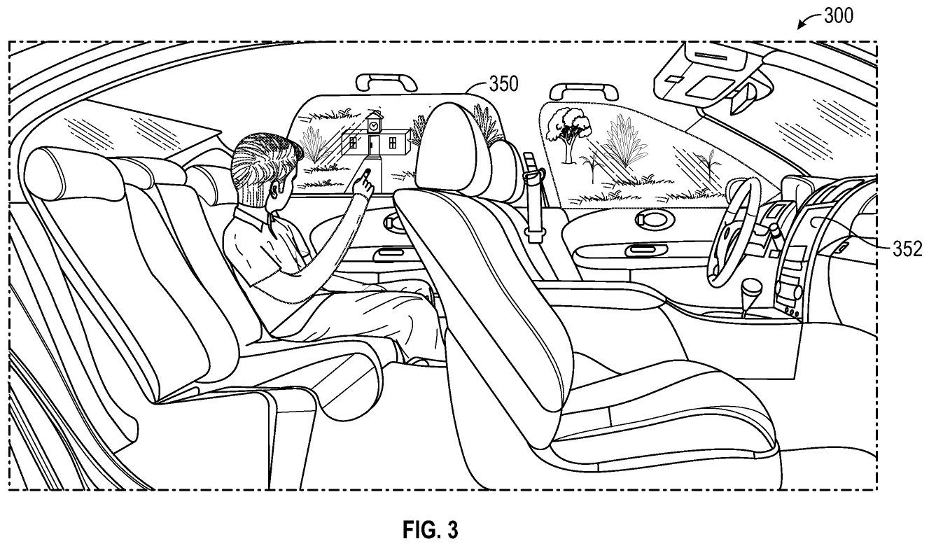

FIG. 3 is a schematic illustration of an example implementation of a landmark tour, in accordance with one or more embodiments of the disclosure. In the example of FIG. 3, a vehicle (e.g., the vehicle 110 of FIG. 1, the vehicle being autonomous) may drive the user to nearby locations of interest, such as a given landmark 350, and may present additional information as the user views the location and/or as the vehicle drives past the location of interest. The additional information may be audio and/or visual content that may be downloaded or streamed from one or more third-party services. For example, content related to a location may be associated with a given location based at least in part on an address, a zip code, GPS coordinates, a city, and/or other location identifying information. The content may be presented using the vehicle's display 352 and/or audio system, or the user device's display and/or audio system. In another embodiment, the audio may or may not be pre-recorded. For example, the audio may be automatically electronically generated from the text of a website (e.g., Wikipedia, online travel sites, and the like).

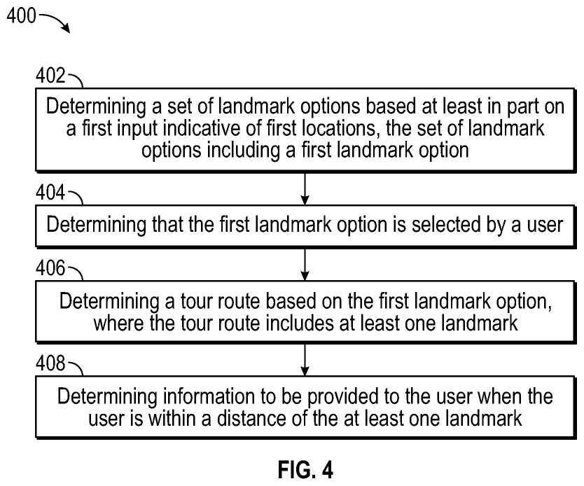

FIG. 4 shows an example process flow for a method of providing vehicle tours and landmark information, in accordance with example embodiments of the disclosure. At block 402, the process flow 400 may include determining a set of landmark options based at least in part on a first input indicative of first locations, the set of landmark options including a first landmark option. In various embodiments, the first landmark option may tailored based on a passenger's and/or a driver's preferences. For example, if the passengers and/or drivers are interested in food, they can be given information and/or landmarks about high-rating local restaurants in the area (e.g., the story behind a restaurant's origination, the types of unique food offerings, comparisons to other restaurants in the area, combinations thereof, and/or the like). As another example, if the passengers and/or drivers are interested in history, a historic landmark and/or a battle that took place close by a landmark on the route that the passengers and/or drivers are traveling may be presented as landmark options.

At block 404, the process flow 400 may include determining that the first landmark option is selected by a user. In one embodiment, the users may select the first landmark option using any suitable input at a vehicle device or a user device (e.g., a mobile phone). For example, the users (e.g., the passengers and/or drivers) may provide an input (e.g., a voice input, a textual input, a video input, combinations thereof, and/or the like) to select the first landmark and additionally, request information about their location to a device associated with a vehicle in which they are riding.

At block 406, the process flow 400 may include determining a tour route based on the first landmark option, wherein the tour route includes at least one landmark. In another embodiment, determining the tour route may include selecting the tour route from a set of historical tour routes having a ranking above a predetermined threshold. In one embodiment, the tour route may be based at least in part on a user preference or a user profile.

At block 408, the process flow 400 may include determining information to be provided to the user when the user is within a distance of the at least one landmark. In one embodiment, a query may be received from one or more users, and information may be determined based at least in part on the query. In one embodiment, a tour route history associated with the user and associated with a location may be determined, and a percentage of tour routes taken by the user in the location may be determined based on the tour route. In one embodiment, a second tour route may be based on the tour route history. The second tour route may then be taken by the user. The source tour route may be more suitable than the first tour route according to the user's preferences.

FIG. 5 is a schematic illustration of an example autonomous vehicle in accordance with one or more embodiments of the disclosure. Referring to FIG. 5, an example autonomous vehicle 500 (which may correspond to the vehicle 110 of FIG. 1) may include a powerplant 502 (such as a combustion engine and/or an electric motor) that provides torque to drive wheels 504 that propel the vehicle forward or backward. Autonomous vehicle operation, including propulsion, steering, braking, navigation, and the like, may be controlled autonomously by a vehicle controller 506. For example, the vehicle controller 506 may be configured to receive feedback from one or more sensors (e.g., sensor system 534, etc.) and other vehicle components to determine road conditions, vehicle positioning, and so forth. The vehicle controller 506 may also ingest data from the speed monitor and yaw sensor, as well as the tires, brakes, motor, and other vehicle components. The vehicle controller 506 may use the feedback and the route/map data of the route to determine actions to be taken by the autonomous vehicle, which may include operations related to the engine, steering, braking, and so forth. Control of the various vehicle systems may be implemented using any suitable mechanical means, such as servo motors, robotic arms (e.g., to control steering wheel operation, acceleration pedal, brake pedal, etc.), and so forth. The controller 506 may be configured to process the route data for a neighborhood tour, and may be configured to interact with the user via the user interface devices in the car and/or by communicating with the user's user device.

The vehicle controller 506 may include one or more computer processors coupled to at least one memory. The vehicle 500 may include a braking system 508 having disks 510 and calipers 512. The vehicle 500 may include a steering system 514. The steering system 514 may include a steering wheel 516, a steering shaft 518 interconnecting the steering wheel to a steering rack 520 (or steering box). The front and/or rear wheels 504 may be connected to the steering rack 520 via an axle 522. A steering sensor 524 may be disposed proximate to the steering shaft 518 to measure a steering angle. The vehicle 500 also includes a speed sensor 526 that may be disposed at the wheels 504 or in the transmission. The speed sensor 526 is configured to output a signal to the controller 506 indicating the speed of the vehicle. A yaw sensor 528 is in communication with the controller 506 and is configured to output a signal indicating the yaw of the vehicle 500.

The vehicle 500 includes a cabin having a display 530 in electronic communication with the controller 506. The display 530 may be a touchscreen that displays information to the passengers of the vehicle and/or functions as an input, such as whether or not the rider is authenticated. A person having ordinary skill in the art will appreciate that many different display and input devices are available and that the present disclosure is not limited to any particular display. An audio system 532 may be disposed within the cabin and may include one or more speakers for providing information and entertainment to the driver and/or passengers. The audio system 532 may also include a microphone for receiving voice inputs. The vehicle may include a communications system 536 that is configured to send and/or receive wireless communications via one or more networks. The communications system 536 may be configured for communication with devices in the car or outside the car, such as a user's device, other vehicles, etc.

The vehicle 500 may also include a sensor system for sensing areas external to the vehicle. The vision system may include a plurality of different types of sensors and devices such as cameras, ultrasonic sensors, RADAR, LIDAR, and/or combinations thereof. The vision system may be in electronic communication with the controller 506 for controlling the functions of various components. The controller may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers and/or computer processors. The controller 506 may receive signals from the sensor system 534 and may include memory containing machine-readable instructions for processing the data from the vision system. The controller 506 may be programmed to output instructions to at least the display 530, the audio system 532, the steering system 514, the braking system 508, and/or the powerplant 502 to autonomously operate the vehicle 500.

FIG. 6 is a schematic illustration of an example server architecture for one or more server(s) 600 in accordance with one or more embodiments of the disclosure. The server 600 illustrated in the example of FIG. 6 may correspond to a computer system configured to implement the functionality discussed with respect to FIGS. 1-5. Some or all of the individual components may be optional and/or different in various embodiments. In some embodiments, the server 600 illustrated in FIG. 6 may be located at an autonomous vehicle 640. For example, some or all or the hardware and functionality of the server 600 may be provided by the autonomous vehicle 640. The server 600 may be in communication with the autonomous vehicle 640, as well as one or more third-party servers 644 (e.g., servers that store tour data, map data servers, etc.), and one or more user devices 650. The autonomous vehicle 640 may be in communication with the user device 650.

The server 600, the third-party server 644, the autonomous vehicle 640, and/or the user device 650 may be configured to communicate via one or more networks 642. The autonomous vehicle 640 may additionally be in wireless communication 646 with the user device 650 via a connection protocol such as Bluetooth or Near Field Communication. The server 600 may be configured to communicate via one or more networks 642. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server 600 may include one or more processors (processor(s)) 602, one or more memory devices 604 (also referred to herein as memory 604), one or more input/output (I/O) interface(s) 606, one or more network interface(s) 608, one or more sensor(s) or sensor interface(s) 610, one or more transceiver(s) 612, one or more optional display components 614, one or more optional camera(s)/speaker(s)/microphone(s) 616, and data storage 620. The server 600 may further include one or more bus(es) 618 that functionally couple various components of the server 600. The server 600 may further include one or more antenna(s) 630 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit the exchange of information (e.g., data (including computer-executable code), signaling, etc.) between various components of the server 600. The bus(es) 618 may include, without limitation, a memory bus or a memory controller, a peripheral bus, an accelerated graphics port, and so forth. The bus(es) 618 may be associated with any suitable bus architecture.

The memory 604 of the server 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

The data storage 620 may include removable storage and/or non-removable storage including, but not limited to, magnetic storage, optical disk storage, and/or tape storage. The data storage 620 may provide non-volatile storage of computer-executable instructions and other data.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. More specifically, the data storage 620 may store one or more operating systems (O/S) 622; one or more database management systems (DBMS s) 624; and one or more program module(s), applications, engines, computer-executable code, scripts, or the like such as, for example, one or more routing module(s) 626 and/or one or more driving module(s) 628. Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The processor(s) 602 may be configured to access the memory 604 and execute the computer-executable instructions loaded therein. For example, the processor(s) 602 may be configured to execute the computer-executable instructions of the various program module(s), applications, engines, or the like of the server 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit.

Referring now to functionality supported by the various program module(s) depicted in FIG. 6, the routing module(s) 626 may include computer-executable instructions, code, or the like that responsive to execution by one or more of the processor(s) 602 may perform one or more blocks of the process flows herein and/or functions including, but not limited to, determining points of interest, determining historical user selections or preferences, determining roam radiuses, determining optimal routing, determining real-time traffic data, determining suggested routing options, sending and receiving data, controlling autonomous vehicle features, and the like.

The routing module 626 may be in communication with the autonomous vehicle 640, the third-party server 644, the user device 650, and/or other components. For example, the routing module may send route data to the autonomous vehicle 640, receive tour data from the third-party server 644, receive user selections from the user device 650, and so forth.

The driving module(s) 628 may include computer-executable instructions, code, or the like that responsive to execution by one or more of the processor(s) 602 may perform functions including, but not limited to, sending and/or receiving data, determining whether a user has left or entered an autonomous vehicle, determining whether an autonomous vehicle should wait for a user, determining whether a user is in proximity to a vehicle, and the like. In some embodiments, the driving module 628 may be partially or wholly integral to the autonomous vehicle 640.

The driving module 628 may be in communication with the autonomous vehicle 640, the third-party server 644, the user device 650, and/or other components. For example, the driving module may send traffic data or ride requests to the autonomous vehicle 640, receive road condition data from the third-arty server 644, receive user selections of route preferences from the user device 650, and so forth.

Referring now to other illustrative components depicted as being stored in the data storage 620, the O/S 622 may be loaded from the data storage 620 into the memory 604 and may provide an interface between other application software executing on the server 600 and the hardware resources of the server 600.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. As noted, in various embodiments, databases may store at least portions of the tours and/or routes. In another embodiment, the databases may be provided on an open marketplace where users and/or companies can contribute their own catered tours.

Referring now to other illustrative components of the server 600, the input/output (I/O) interface(s) 606 may facilitate the receipt of input information by the server 600 from one or more I/O devices as well as the output of information from the server 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. The I/O interface(s) 606 may also include a connection to one or more of the antenna(s) 630 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The server 600 may further include one or more network interface(s) 608 via which the server 600 may communicate with any of a variety of other systems, platforms, networks, devices, and so forth. The network interface(s) 608 may enable communication, for example, with one or more wireless routers, one or more host servers, one or more web servers, and the like via one or more networks.

The sensor(s)/sensor interface(s) 610 may include or may be capable of interfacing with any suitable type of sensing device such as, for example, inertial sensors, force sensors, thermal sensors, photocells, and so forth.

The display component(s) 614 may include one or more display layers, such as LED or LCD layers, touchscreen layers, protective layers, and/or other layers. The optional camera(s) 616 may be any device configured to capture ambient light or images. The optional microphone(s) 616 may be any device configured to receive analog sound input or voice data. The microphone(s) 616 may include microphones used to capture sound.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module.

It should further be appreciated that the server 600 may include alternate and/or additional hardware, software, or firmware components beyond those described or depicted without departing from the scope of the disclosure.

The user device 650 may include one or more computer processor(s) 652, one or more memory devices 654, and one or more applications, such as an autonomous vehicle application 656. Other embodiments may include different components.

The processor(s) 652 may be configured to access the memory 654 and execute the computer-executable instructions loaded therein. For example, the processor(s) 652 may be configured to execute the computer-executable instructions of the various program module(s), applications, engines, or the like of the device to cause or facilitate various operations to be performed in accordance with one or more embodiments of the disclosure. The processor(s) 652 may include any suitable processing unit capable of accepting data as input, processing the input data in accordance with stored computer-executable instructions, and generating output data. The processor(s) 652 may include any type of suitable processing unit.

The memory 654 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the user device 650, the autonomous vehicle application 656 may be a mobile application executable by the processor 652 that can be used to present options and/or receive user inputs of information related to autonomous vehicle ride requests, tour presentation and selection, neighborhood tour content, ride scheduling, and the like.

The autonomous vehicle 640 may include one or more computer processor(s) 660, one or more memory devices 662, one or more sensors 664, and one or more applications, such as an autonomous driving application 666. Other embodiments may include different components. A combination or sub combination of these components may be integral to the controller 506 in FIG. 5.

The processor(s) 660 may be configured to access the memory 662 and execute the computer-executable instructions loaded therein. For example, the processor(s) 660 may be configured to execute the computer-executable instructions of the various program module(s), applications, engines, or the like of the device to cause or facilitate various operations to be performed in accordance with one or more embodiments of the disclosure. The processor(s) 660 may include any suitable processing unit capable of accepting data as input, processing the input data in accordance with stored computer-executable instructions, and generating output data. The processor(s) 660 may include any type of suitable processing unit.

The memory 662 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the autonomous vehicle 640, the autonomous driving application 666 may be a mobile application executable by the processor 660 that can be used to receive data from the sensors 664, receive and execute tour data, and/or control operation of the autonomous vehicle 640.

One or more operations of the methods, process flows, and use cases of FIGS. 1-5 may be performed by a device having the illustrative configuration depicted in FIG. 6, or more specifically, by one or more engines, program module(s), applications, or the like executable on such a device. It should be appreciated, however, that such operations may be implemented in connection with numerous other device configurations.

The operations described and depicted in the illustrative methods and process flows of FIGS. 1-6 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

### EXAMPLE EMBODIMENTS

Example embodiments of the disclosure may include one or more of the following examples:

Example 1 may include a device, comprising: at least one memory comprising computer-executable instructions; and one or more computer processors configured to access the at least one memory and execute the computer-executable instructions to: determine a set of landmark options based at least in part on an input indicative of locations, the set of landmark options comprising a landmark option; determine that the landmark option is selected by a user; determine a tour route based on the landmark option, wherein the tour route includes at least one landmark; and determine information to be provided to the user when the user is within a distance of the at least one landmark.

Example 2 may include the device of example 1, wherein the information comprises an audio signal.

Example 3 may include the device of example 1 and/or some other example herein, wherein the information comprises information about a historical event associated with the at least one landmark.

Example 4 may include the device of example 1 and/or some other example herein, wherein the one or more computer processors are further configured to execute the computer-executable instructions to receive a query from the user, and determine the information based at least in part on the query.

Example 5 may include the device of example 1 and/or some other example herein, wherein determining the tour route comprises selecting the tour route from a set of historical tour routes having a ranking above a predetermined threshold.

Example 6 may include the device of example 1 and/or some other example herein, wherein determining the tour route is based at least in part on a user preference or a user profile.

Example 7 may include the device of example 1 and/or some other example herein, wherein the device is associated with an autonomous vehicle.

Example 8 may include the device of example 1 and/or some other example herein, wherein the one or more computer processors are further configured to execute the computer-executable instructions to determine a tour route history associated with the user and associated with a location, and determine a percentage of tour routes taken by the user in the location based on the tour route.

Example 9 may include the device of example 8 and/or some other example herein, wherein the one or more computer processors are further configured to execute the computer-executable instructions to determine a second tour route based on the tour route history.

Example 10 may include a method, comprising: determining a set of landmark options based at least in part on an input indicative of locations, the set of landmark options comprising a landmark option; determining that the landmark option is selected by a user; determining a tour route based on the landmark option, wherein the tour route includes at least one landmark; and determining information to be provided to the user when the user is within a distance of the at least one landmark.

Example 11 may include the method of example 10, further comprising receiving a query from the user, and determining the information based at least in part on the query.

Example 12 may include the method of example 10 and/or some other example herein, wherein determining the tour route comprises selecting the tour route from a set of historical tour routes having a ranking above a predetermined threshold.

Example 13 may include the method of example 10 and/or some other example herein, wherein determining the tour route is based at least in part on a user preference or a user profile.

Example 14 may include the method of example 10 and/or some other example herein, further comprising determining a tour route history associated with the user and associated with a location, and determining a percentage of tour routes taken by the user in the location based on the tour route.

Example 15 may include the method of example 14 and/or some other example herein, further comprising determining a second tour route based on the tour route history.

Example 16 may include a non-transitory computer-readable medium storing computer-executable instructions which, when executed by a processor, cause the processor to perform operations comprising: determining a set of landmark options based at least in part on an input indicative of locations, the set of landmark options comprising a landmark option; determining that the landmark option is selected by a user; determining a tour route based on the landmark option, wherein the tour route includes at least one landmark; and determining information to be provided to the user when the user is within a distance of the at least one landmark.

Example 17 may include the non-transitory computer-readable medium of example 16, wherein the computer-executable instructions further cause the processor to perform operations comprising receiving a query from the user, and determining the information based at least in part on the query.

Example 18 may include the non-transitory computer-readable medium of example 16 and/or some other example herein, wherein the computer-executable instructions that cause the processor to perform operations comprising determining the tour route further comprise computer-executable instructions that cause the processor to perform operations comprising selecting the tour route from a set of historical tour routes having a ranking above a predetermined threshold.

Example 19 may include the non-transitory computer-readable medium of example 16 and/or some other example herein, wherein the computer-executable instructions that cause the processor to perform operations comprising determining the tour route are based at least in part on a user preference or a user profile.

Example 20 may include the non-transitory computer-readable medium of example 16 and/or some other example herein, wherein the computer-executable instructions further cause the processor to perform operations comprising determining a tour route history associated with the user and associated with a location, and determining a percentage of tour routes taken by the user in the location based on the tour route.

What is claimed is:

1. A device, comprising:
at least one memory comprising computer-executable instructions; and
one or more computer processors configured to access the at least one memory and execute the computer-executable instructions to:
determine a set of landmark options based at least in part on an input indicative of locations, the set of landmark options comprising a landmark option;
determine that the landmark option is selected by a user;
determine a tour route based on the landmark option, wherein the tour route includes at least one landmark; and
determine information to be provided to the user when the user is within a distance of the at least one landmark.

2. The device of claim 1, wherein the information comprises an audio signal.

3. The device of claim 1, wherein the information comprises information about a historical event associated with the at least one landmark.

4. The device of claim 1, wherein the one or more computer processors are further configured to execute the computer-executable instructions to receive a query from the user, and determine the information based at least in part on the query.

5. The device of claim 1, wherein determining the tour route comprises selecting the tour route from a set of historical tour routes having a ranking above a predetermined threshold.

6. The device of claim 1, wherein determining the tour route is based at least in part on a user preference or a user profile.

7. The device of claim 1, wherein the device is associated with an autonomous vehicle.

8. The device of claim 1, wherein the one or more computer processors are further configured to execute the computer-executable instructions to determine a tour route history associated with the user and associated with a location, and determine a percentage of tour routes taken by the user in the location based on the tour route.

9. The device of claim 8, wherein the one or more computer processors are further configured to execute the computer-executable instructions to determine a second tour route based on the tour route history.

10. A method, comprising:
determining a set of landmark options based at least in part on an input indicative of locations, the set of landmark options comprising a landmark option;
determining that the landmark option is selected by a user;
determining a tour route based on the landmark option, wherein the tour route includes at least one landmark; and
determining information to be provided to the user when the user is within a distance of the at least one landmark.

11. The method of claim 10, further comprising receiving a query from the user, and determining the information based at least in part on the query.

12. The method of claim 10, wherein determining the tour route comprises selecting the tour route from a set of historical tour routes having a ranking above a predetermined threshold.

13. The method of claim 10, wherein determining the tour route is based at least in part on a user preference or a user profile.

14. The method of claim 10, further comprising determining a tour route history associated with the user and associated with a location, and determining a percentage of tour routes taken by the user in the location based on the tour route.

15. The method of claim 14, further comprising determining a second tour route based on the tour route history.

16. A non-transitory computer-readable medium storing computer-executable instructions which, when executed by a processor, cause the processor to perform operations comprising:
determining a set of landmark options based at least in part on an input indicative of locations, the set of landmark options comprising a landmark option;
determining that the landmark option is selected by a user;
determining a tour route based on the landmark option, wherein the tour route includes at least one landmark; and
determining information to be provided to the user when the user is within a distance of the at least one landmark.

17. The non-transitory computer-readable medium of claim 16, wherein the computer-executable instructions further cause the processor to perform operations comprising receiving a query from the user, and determining the information based at least in part on the query.

18. The non-transitory computer-readable medium of claim 16, wherein the computer-executable instructions that cause the processor to perform operations comprising determining the tour route further comprise computer-executable instructions that cause the processor to perform operations comprising selecting the tour route from a set of historical tour routes having a ranking above a predetermined threshold.

19. The non-transitory computer-readable medium of claim 16, wherein the computer-executable instructions that cause the processor to perform operations comprising determining the tour route are based at least in part on a user preference or a user profile.

20. The non-transitory computer-readable medium of claim 16, wherein the computer-executable instructions further cause the processor to perform operations comprising determining a tour route history associated with the user and associated with a location, and determining a percentage of tour routes taken by the user in the location based on the tour route.
